(19) United States
(12) Patent Application Publication
(10) Pub. No.: US 2014/0144865 A1
(43) Pub. Date: May 29, 2014

(54) Orthodontic Feeding Nipple

(71) Applicant: Laurens Last, Bosch En Duin (NL)

(72) Inventor: Laurens Last, Bosch En Duin (NL)

(73) Assignee: IPN IP B.V., Houten (NL)

(21) Appl. No.: 13/825,378

(22) PCT Filed: Sep. 23, 2011
(86) PCT No.: PCT/EP11/66571

§ 371 Date: May 29, 2013

(30) Foreign Application Priority Data
Sep. 23, 2010 (NL) 2005388

(51) Int. Cl. A61J 11/00

(52) U.S. Cl. CPC A61J 11/007
USPC 215/11.5; 215/11.1

(57) ABSTRACT

An orthodontic feeding nipple adapted for attachment to a feeding bottle, said feeding nipple having a monolithic, single-walled hollow body of elastomeric material. The body has an annular securing flange at a base end of the body. An inner contour of the flange defines an inlet opening for liquid into said feeding nipple. A bottle ventilation hole is present in said flange allowing the passage of air into the feeding bottle. The body has a hollow shell portion integral with the flange at the inner contour thereof. The shell portion has a lower shell portion, a central shell portion, and a top shell portion. The top shell portion includes a dispensing holes containing wall section that is provided with a group of multiple liquid dispensing holes. This wall section is arranged at the side of the ventilation hole and has a substantially uniform wall thickness in the region of the group of dispensing holes. Each dispensing hole is conical with a smallest diameter at the inside of the shell portion and a largest diameter at the outside of the shell portion. The outer face of the wall section is substantially planar and arranged at an angle between 30 and 40° with respect to a plane normal to the plane of the securing flange.

The present invention relates to an orthodontic feeding nipple adapted for attachment to a feeding bottle. The invention further relates to a feeding bottle provided with such a nipple.

It has been found that known orthodontic feeding nipples are not satisfactory. In particular the outflow of liquid via the dispensing holes is found to be variable to an unsatisfactory degree.

The object of the invention therefore is to provide an orthodontic feeding nipple, which provides an improved outflow of liquid.

To this end the invention provides an orthodontic feeding nipple according to claim 1. In said feeding nipple the shape of the tip end region of the nipple enhances the outflow of liquid. This shape is mainly governed by the inverted V arrangement of the wall section containing the dispensing holes and the opposed wall section, with an angle of between 75° and 95° to one another when seen in a vertical median plane of the nipple. This is done in combination with the arrangement of said wall section containing the dispensing holes so that the outer face of said wall section is arranged at an angle between 30° and 40° with respect to a reference plane normal to the plane of the securing flange, preferably between 33° and 38°.

A further improvement is reached in an embodiment wherein said opposed wall section extends over a length of between 8 and 12 millimeters from the tip end of the nipple, and wherein the wall section containing the dispensing holes extends over a length of between 4 and 8 millimeters from the tip end of the nipple—when seen in vertical cross-section view in said median plane.

Preferably the opposed wall section is lightly inwardly curved.

Preferably the outer face of the wall section with dispensing holes is substantially planar.

For improved dispensing preferably each dispensing hole is conical with a smallest diameter at the inside of the shell portion and a largest diameter at the outer face of the wall section.

More preferably each dispensing hole has a first conical portion with a first cone angle, said first conical portion adjoining the inside of the shell, and a second conical portion, of smaller axial length than the first conical portion and adjoining said first conical portion, wherein said second conical portion extends to the outer face of said wall section and has a greater cone angle than said first conical portion.

In a further preferred embodiment the second conical portions of the dispensing openings adjoin one another in the outer face of the dispensing holes containing wall section.

In a preferred embodiment three dispensing holes are present in triangular arrangement, one hole forming an upper dispensing hole closely adjacent the tip end, the other two holes forming lower dispensing holes, preferably the upper dispensing hole being arranged in the vertical reference plane of the nipple through a ventilation hole or valve that is arranged in the securing flange.

Preferably a bottle ventilation valve is present in said flange allowing the passage of air into the feeding bottle, most preferably said ventilation valve being arranged in said median plane of the nipple at the side of the wall section provided with dispensing holes.

The invention also relates to a feeding bottle provided with a feeding nipple as disclosed herein.

The invention also relates to a method of manufacturing the inventive feeding nipple, wherein said nipple is moulded as a monolithic, single walled hollow body of elastic material.

The invention will now be explained in more detail with reference to the drawings. In the drawings:

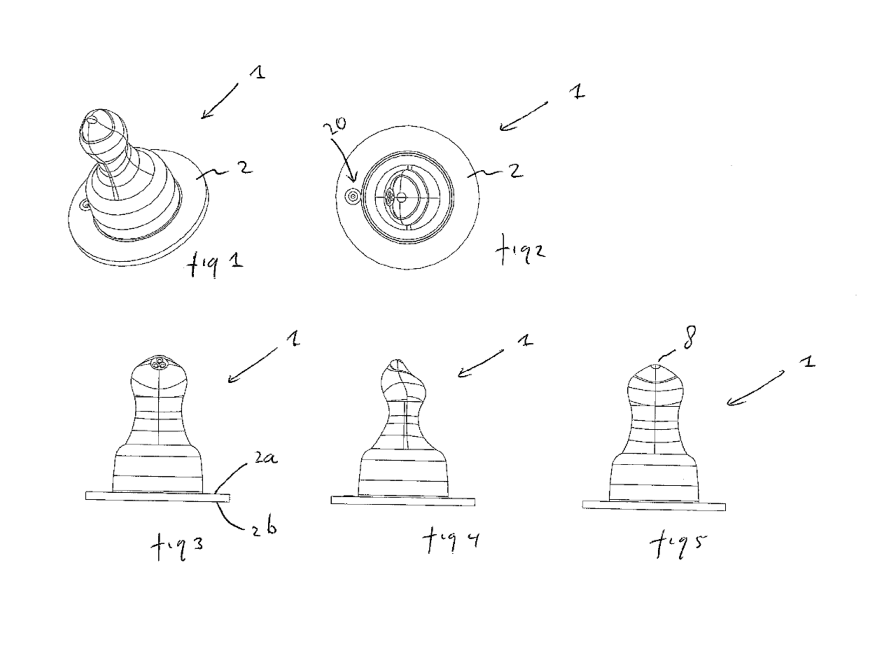

FIG. 1 shows an exemplary embodiment of the orthodontic feeding nipple in perspective view,

FIG. 2 shows the nipple of FIG. 1 from above,

FIG. 3 shows the nipple of FIG. 1 in front view,

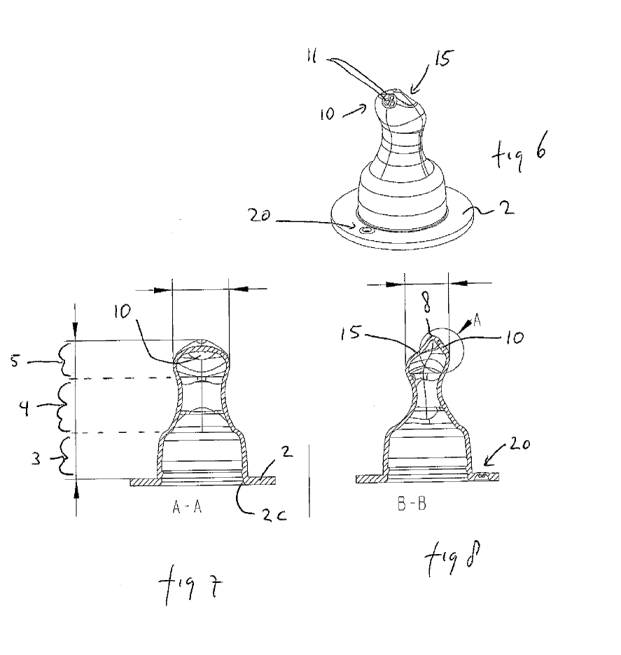

FIG. 4 shows the nipple of FIG. 1 in side view,

FIG. 5 shows the nipple of FIG. 1 in rear view,

FIG. 6 shows the nipple of FIG. 1 in a different perspective view,

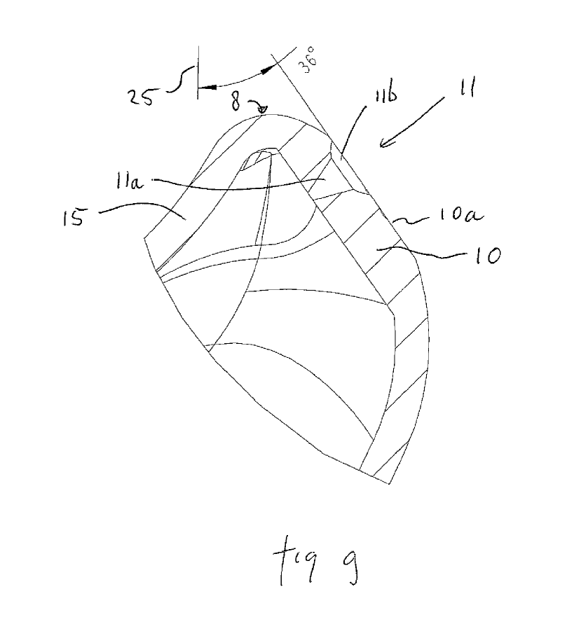

FIG. 7 shows a vertical cross-section of the nipple of FIG. 1 in a plane at right angles to the median plane of the nipple,

FIG. 8 shows a vertical cross-section of the nipple of FIG. 1 in the median plane of the nipple,

FIG. 9 shows on an enlarged scale the tip end region of the nipple of FIG. 1 in cross-section along the median plane of the nipple.

The exemplary embodiment of the orthodontic feeding nipple according to the invention will now be discussed in more detail.

The nipple 1 is adapted for attachment to a feeding bottle, here—as is preferred—via a securing ring to be screwed onto the threaded neck of the feeding bottle. This arrangement is known in the art, but other ways of attachment, e.g. with a snap fit, bayonet, may also be used.

The nipple 1 has been formed via injection-moulding of a suitable elastic material, e.g. rubber, silicone, an elastomer, etc. Materials suitable for use in nipples for baby and child feeding bottles are well known in the art.

The nipple 1 has a monolithic, single-walled hollow body of elastic material.

The body 1 has an annular securing flange 2 at a base end of the body. The flange 2 has an upper face 2a, a lower face 2b, an outer contour, and an inner contour 2c defining an inlet opening for liquid into said feeding nipple. As is preferred the upper and lower faces 2a, 2b of the flange are planar.

The body 1 has a hollow shell portion integral with the flange 2 at the inner contour thereof. The shell portion includes a tip end 8 remote from the flange 2, here the nipple having a total height above the upper face 2a of 37 millimeters.

The shell portion is composed here of three portions, namely a lower shell portion 3, a central shell portion 4, and a top shell portion 5. Each portion has a specific main function, the lower shell portion receiving the liquid from the bottle and providing a greatest diameter portion of the nipple, the central shell portion forming a throat in the nipple, and the top shell portion serving to dispense the liquid via one or more dispensing holes therein.

As is preferred the lower shell portion 3 extends over a height of between 8 and 14 millimeters with respect to the upper face 2a of the securing flange 2. As is preferred the lower shell portion 3 has a constant cross-section over its height, or—even more preferred—a lightly inward tapering cross-section such that the internal cross-section at the upper end of the lower portion is at least 80% of the internal cross-section of the inlet opening.

The central shell portion 4 extends—as is preferred—over a height between 8 and 14 millimeters between the lower shell portion 3 and the top shell portion 5.

The central shell portion 4 has a lower section tapering inward to a throat of the nipple at a greater angle than the taper angle of the lower shell portion 3 and an upper section tapering from said throat outward to the top shell portion 5.

The top shell portion forms the tip end of the nipple at a height of between 33 and 40 millimeters with respect to the upper face 2a of the securing flange 2, here 37 millimeters.

The top shell portion includes a non-recessed wall section 10 that contains a group of multiple distinct dispensing holes 11, here—as is preferred—three dispensing holes 11 in a triangular arrangement.

The wall section 10 is of substantially uniform wall thickness in the region of the group of dispensing holes 11 and has an outer face 10a.

The outer face 10a of the wall section 10 is arranged at an angle between 30° and 40° with respect to a reference plane 25 normal to the plane of the securing flange, here—as is preferred—between 33° and 38°, here 36°.

The wall section 10a with the holes 11 therein is arranged directly adjacent the tip end of the nipple, here within 3 millimeters from the tip end.

The top shell section 5 also comprises an opposed wall section 15 generally opposite the dispensing holes containing wall section 10. When seen in vertical cross-section view of the nipple in the median plane of the nipple (see FIG. 8) these wall sections 10, 15 generally form an inverted V with said wall sections 10, 15 having an angle between 75° and 95° to one another.

It has been found that this spatial arrangement of the walls 10, 15 that define the space within the nipple directly in front of the group of dispensing holes 11, in combination with the arrangement of the wall 10 that has the holes 11 therein with respect to the base, results in a top shell portion that produces a reliable and stable outflow of liquid when the nipple is used for feeding a baby or child.

As can be seen the flange 2 has a single ventilation valve 20 therein, preferably located in said median plane.

The median plane of the nipple 1 here extends through said valve 20 and the centre of the inlet opening formed by the flange 2.

As is preferred the opposed wall section 15 extends over a length of between 8 and 12 millimeters from the tip end of the nipple. As is preferred the wall section 10 containing the dispensing holes 11 extends over a length of between 4 and 8 millimeters from the tip end of the nipple—when seen in vertical cross-section view in the median plane of the nipple 1.

It will be appreciated that the planar face 10a here lies within the wall section 10 that is rounded, e.g. shaped as part of a sphere, whereas the wall section 15 is more planar (somewhat curved inward as is preferred) to arrive at an orthodontic shape of the top shell portion.

The provision of the holes 11 in a wall section of substantially uniform wall thickness and with a planar outer face 10a is advantageous for the injection moulding process and quality of the holes 11 obtained thereby, taking into account that the holes 11 are small diameter holes of generally conical design.

As is preferred, and can be seen in FIG. 9, each dispensing hole 11 is conical with a smallest diameter at the inside of the shell portion and a largest diameter at the outer face of the wall section. even more preferred each dispensing hole 11 has a first conical portion 11a with a first cone angle, said first conical portion adjoining the inside of the shell, and a second conical portion 11b of smaller axial length than the first conical portion 11a and adjoining said first conical portion. This second conical portion 11b extends to the outer face of the wall section 10 and has a greater cone angle than the first conical portion 11a.

As is preferred, the second conical portions of the dispensing openings lie close against one another in the outer face 10a.

As is preferred three dispensing holes 11 are present in triangular arrangement, one hole forming an upper dispensing hole closely adjacent the tip end, the other two holes forming lower dispensing holes, preferably the upper dispensing hole being arranged in the vertical reference plane of the nipple through the ventilation hole or valve 20 in the flange 2.

As is preferred the largest horizontal outer dimension of the top shell portion in transverse direction, as indicated in FIG. 7, is between 12 and 16 millimetres.

As is preferred the largest horizontal dimension of the top shell portion in the median plane, as indicate in FIG. 8, is between 10 and 13 millimeters.

1. An orthodontic feeding nipple adapted for attachment to a feeding bottle comprising:
a monolithic, single-walled hollow body of elastic material having an annular securing flange at a base end of the body, said flange extending in a plane and having an upper face, a lower face, an outer contour, and an inner contour that defines an inlet opening for liquid from said feeding bottle into said feeding nipple,
said body having a hollow shell portion integral with said securing flange at the inner contour thereof, said shell portion including a tip end remote from said securing flange,
wherein the shell portion has a lower shell portion, a central shell portion, and a top shell portion,
wherein said lower shell portion extends over a height of between 8 and 14 millimeters with respect to the upper face of the securing flange,
wherein said lower shell portion has a constant cross-section over its height, or a lightly inward tapering cross-section having a taper angle such that the internal cross-section at the upper end of the lower shell portion is at least 80% of the internal cross-section of the inlet opening,
wherein said central shell portion extends over a height between 8 and 14 millimeters between the lower shell portion and the top shell portion,
wherein said central shell portion has a lower section tapering inward to a throat of the feeding nipple, at a greater angle than the taper angle of the lower shell portion if said lower shell portion tapers lightly inward, and said central shell portion having an upper section tapering from said throat outward to the top shell portion,
wherein said top shell portion forms the tip end at a height of between 33 and 40 millimeters with respect to the upper face of the securing flange,
wherein the top shell portion includes a non-recessed wall section that contains a region with a group of multiple distinct dispensing holes,
wherein said non-recessed wall section is of substantially uniform wall thickness in the region of the group of dispensing holes, and has an outer face,
wherein the outer face of the non-recessed wall section is arranged at an angle between 30° and 40° with respect to a reference plane normal to the plane of the securing flange,
wherein said non-recessed wall section is arranged directly adjacent the tip end of the nipple,
wherein the top shell portion furthermore comprises an opposed wall section opposite the dispensing holes containing non-recessed wall section,
and wherein—in vertical cross-section view of the nipple in a median plane of the nipple—said non-recessed and opposed wall sections of the top shell portion generally form an inverted V with said non-recessed wall sections having an angle between 75° and 95° to one another.

2. The feeding nipple according to claim 1, wherein said opposed non-recessed wall section extends over a length of between 8 and 12 millimeters from the tip end of the nipple, wherein the non-recessed wall section containing the dispensing holes extends over a length of between 4 and 8 millimeters from the tip end of the nipple—when seen in vertical cross-section view in said median plane.

3. The feeding nipple according to claim 1, wherein each dispensing hole is conical with a smallest diameter at the inside of the shell portion and a largest diameter at the outer face of the non-recessed wall section.

4. The feeding nipple according to claim 3, wherein each dispensing hole has a first conical portion with a first cone angle, said first conical portion adjoining the inside of the top shell portion, and a second conical portion, of smaller axial length than the first conical portion and adjoining said first conical portion, wherein said second conical portion extends to the outer face of said non-recessed wall section and has a greater cone angle than said first conical portion, wherein the second conical portions of the dispensing openings preferably adjoin one another in said outer face.

5. The feeding nipple according to claim 1, wherein the non-recessed wall section has three dispensing holes are present in triangular arrangement, one dispensing hole forming an upper dispensing hole closely adjacent the tip end, the other two dispensing holes forming lower dispensing holes.

6. A feeding bottle provided with a feeding nipple according to claim 1.

7. The feeding nipple according to claim 1, wherein the outer face of the non-recessed wall section is arranged at an angle between 33° and 38° with respect to a reference plane normal to the plane of the securing flange.

8. The feeding nipple according to claim 1, wherein said non-recessed wall section is arranged within 3 millimeters from the tip end of the nipple.

9. The feeding nipple according to claim 1, wherein said non-recessed wall section has three dispensing holes in a triangular arrangement.

10. The feeding nipple according to claim 4, wherein said second conical portions of the dispensing openings adjoin one another in said outer face of said non-recessed wall section.

11. The feeding nipple according to claim 5, wherein the securing flange is provided with a ventilation hole or a ventilation valve, and wherein the upper dispensing hole is arranged in a vertical reference plane of the nipple through said ventilation hole or said ventilation valve.

12. An orthodontic feeding nipple formed of a monolithic, single-walled hollow body of elastic material adapted for attachment to a feeding bottle, the body comprising:
an annular securing flange at a base end, the flange extending in a plane and having an upper face, a lower face, an outer contour, and an inner contour that defines an inlet opening for liquid from a feeding bottle into the feeding nipple;
a hollow shell portion integral with the securing flange at the inner contour thereof, the shell portion including a tip end remote from the securing flange, the shell portion having a lower shell portion, a central shell portion, and a top shell portion;
the lower shell portion extending over a height of between 8 and 14 millimeters with respect to the upper face of the securing flange, the lower shell portion having a cross-section over its height;
the central shell portion extending over a height between 8 and 14 millimeters between the lower shell portion and the top shell portion, the central shell portion having a lower section tapering inward to a throat of the feeding nipple, the central shell portion having an upper section tapering from the throat outward to the top shell portion; and
the top shell portion forming the tip end at a height of between 33 and 40 millimeters with respect to the upper face of the securing flange, the top shell portion including a non-recessed wall section that contains a region with a group of multiple distinct dispensing holes and an opposed wall section opposite the dispensing holes containing non-recessed wall section; and
the non-recessed wall section of the top shell portion having a substantially uniform wall thickness in the region of the group of dispensing holes, and having an outer face arranged at an angle between 30° and 40° with respect to a reference plane normal to the plane of the securing flange, the non-recessed wall section arranged adjacent the tip end of the nipple;
wherein—in vertical cross-section view of the nipple in a median plane of the nipple—the non-recessed and opposed wall sections of the top shell portion generally form an inverted V with the non-recessed wall sections having an angle between 75° and 95° to one another.

13. The feeding nipple according to claim 12, wherein the lower shell portion has a constant cross-section over its height.

14. The feeding nipple according to claim 12, wherein the lower shell portion has a lightly inward tapering cross-section having a taper angle such that the internal cross-section at the upper end of the lower shell portion is at least 80% of the internal cross-section of the inlet opening.

15. The feeding nipple according to claim 14, wherein the lower section of the central shell portion tapers inward to a throat of the feeding nipple at a greater angle than the taper angle of the lower shell portion.

16. The feeding nipple according to claim 12, wherein the opposed non-recessed wall section extends over a length of between 8 and 12 millimeters from the tip end of the nipple, wherein the non-recessed wall section containing the dispensing holes extends over a length of between 4 and 8 millimeters from the tip end of the nipple—when seen in vertical cross-section view in the median plane.

17. The feeding nipple according to claim 12, wherein each dispensing hole is conical with a smallest diameter at the inside of the shell portion and a largest diameter at the outer face of the non-recessed wall section.

18. The feeding nipple according to claim 17, wherein each dispensing hole has a first conical portion with a first cone angle, the first conical portion adjoining the inside of the top shell portion, and a second conical portion, of smaller axial length than the first conical portion and adjoining the first conical portion, wherein the second conical portion extends to the outer face of the non-recessed wall section and has a greater cone angle than the first conical portion, wherein the second conical portions of the dispensing openings preferably adjoin one another in the outer face.

19. The feeding nipple according to claim 12, wherein the non-recessed wall section has three dispensing holes are present in triangular arrangement, one dispensing hole forming an upper dispensing hole closely adjacent the tip end, the other two dispensing holes forming lower dispensing holes.

20. The feeding nipple according to claim 12, wherein the outer face of the non-recessed wall section is arranged at an angle between 33° and 38° with respect to a reference plane normal to the plane of the securing flange, the non-recessed wall section is arranged within 3 millimeters from the tip end of the nipple, the non-recessed wall section has three dispensing holes in a triangular arrangement, the second conical portions of the dispensing openings adjoin one another in the outer face of the non-recessed wall section, and the securing flange is provided with a ventilation hole or a ventilation valve, and wherein the upper dispensing hole is arranged in a vertical reference plane of the nipple through the ventilation hole or the ventilation valve.
